(19) United States
(12) Patent Application Publication
(10) Pub. No.: US 2011/0132684 A1
(43) Pub. Date: Jun. 9, 2011

(54) Ladder brace assembly and method

(76) Inventor: David Allen Wilkins, Taylors, SC (US)

(21) Appl. No.: 12/653,067

(22) Filed: Dec. 8, 2009

(51) Int. Cl. E06C 7/46; E06C 7/18

(52) U.S. Cl. 182/107

(57) ABSTRACT

A ladder brace assembly includes a U-shaped frame member having a base plate and a raised collar section positioned about a portion of an inner periphery thereof. The base plate includes, in a preferred embodiment, four holes for receiving screws, nails, pins, stakes, or other attachment means, which may be used to secure the brace assembly to a surface. Once the pair of ladder braces are in place, the shoes of the ladder may be placed within the U-shaped frames, so that the ladder shoes but up against the raised collar sections, thus preventing the ladder from sliding along the ground while the ladder is in use.

### BACKGROUND OF THE INVENTION

The present invention relates generally to devices used to secure a ladder during use. More specifically, the present invention includes a pair of braces that may be attached to the ground, a deck, or a hard surface such as a driveway or sidewalk, wherein the braces serve to secure the bottom portion of a ladder in a fixed position.

Heretofore, many different devices have been contemplated and used for securing a ladder in place during use. Most such devices include means for securing the upper part of a ladder against a wall, tree, or other substantially vertical surface against which the ladder leans. Other types of ladder stabilizers include may include additional legs or feet, such as the devices shown in U.S. Pat. Nos. 5,551,529; 5,086,876; and 4,632,220. While these types of devices may provide some measure of additional stability, none of these devices are capable of preventing the ladder from skidding across the ground or surface at the foot of the ladder.

It would therefore be desirable to provide a ladder brace assembly that is capable of temporarily securing the bottom portion of a ladder to the surface upon which it stands, in order to prevent the feet of the ladder from moving with respect to that surface. Further, it would be desirable to provide such a device that is inexpensive to manufacture, and easy to use. Additionally, it would be desirable to provide a ladder brace that could be used on any type of solid surface, including concrete, wood decks, soil, and the like.

### BRIEF SUMMARY OF THE INVENTION

In accordance with one aspect of the invention, a ladder brace assembly includes a U-shaped frame member having a base plate and a raised collar section positioned about a portion of an inner periphery thereof. The raised collar section is preferably disposed at about a 90° angle with respect to the base plate. The base plate includes, in a preferred embodiment, four holes for receiving screws, nails, pins, stakes, or other attachment means, which may be used to secure the brace assembly to a surface. The holes may be spaced apart from each other so that when a ladder is used on a deck, pins fit through the holes on the base plate, and the holes are aligned with the spaces between the deck boards.

Alternatively, for hard surfaces such as concrete, double-sided adhesive strips may be employed, wherein the adhesive strips are placed on the underside of the base plate in order to temporarily secure the brace to the hard surface. Optionally, a pivoting pin or rod may be attached to an outer portion of the raised collar section in order to gauge safe angles of the ladder. Angle markings may be printed adjacent the pivoting pin or rod, and when a ladder is set into the braces, the pivoting pin or rod may be raised to a position parallel with the ladder, and then the ladder angle may be checked to ensure that it is positioned at a safe angle for climbing. Another optional attachment is a pivoting angular guide, which is a pivoting cross-brace positioned on the raised collar section and is used to prevent the ladder from being positioned at an angle that is too steep.

When the braces are secured to the ladder support surface (deck, ground, driveway, etc.), each shoe of the ladder is disposed within a U-shaped brace, and each shoe of the ladder buts up against the raised collar section of the corresponding brace, preventing further movement of the ladder with respect to the support surface while the ladder is in use.

### BRIEF DESCRIPTION OF THE DRAWINGS

These and other features, aspects, and advantages of the present invention will become better understood with regard to the following description, appended claims, and accompanying drawings where:

FIG. 1 is an exploded perspective view of one embodiment of the ladder brace assembly, showing the base plate and the raised collar section together with a pivoting angular guide and pins used to secure the ladder brace assembly to a deck;

FIG. 2 is a perspective view of one embodiment of the ladder brace assembly, showing a pivoting angular guide attached thereto;

FIG. 3 is a perspective view of one embodiment of the ladder brace assembly positioned on a deck, wherein the holes on the base plate are in alignment with the spaces between the deck boards;

FIG. 4A is a side cut-away view of one embodiment of the ladder brace assembly, showing the angular guide member at an 8° angle below 90°;

FIG. 4B is a side cut-away view of one embodiment of the ladder brace assembly, showing the angular guide member at an 12° angle below 90°;

FIG. 5A is a side cut-away view of one embodiment of the ladder brace assembly in use with a ladder showing the angular guide member at an 8° angle below 90°;

FIG. 5B is a side cut-away view of one embodiment of the ladder brace assembly in use with a ladder showing the angular guide member at an 12° angle below 90°;

FIG. 6 is a perspective view of one embodiment of the ladder brace assembly, showing stakes used to secure the assembly.

### DETAILED DESCRIPTION OF THE INVENTION

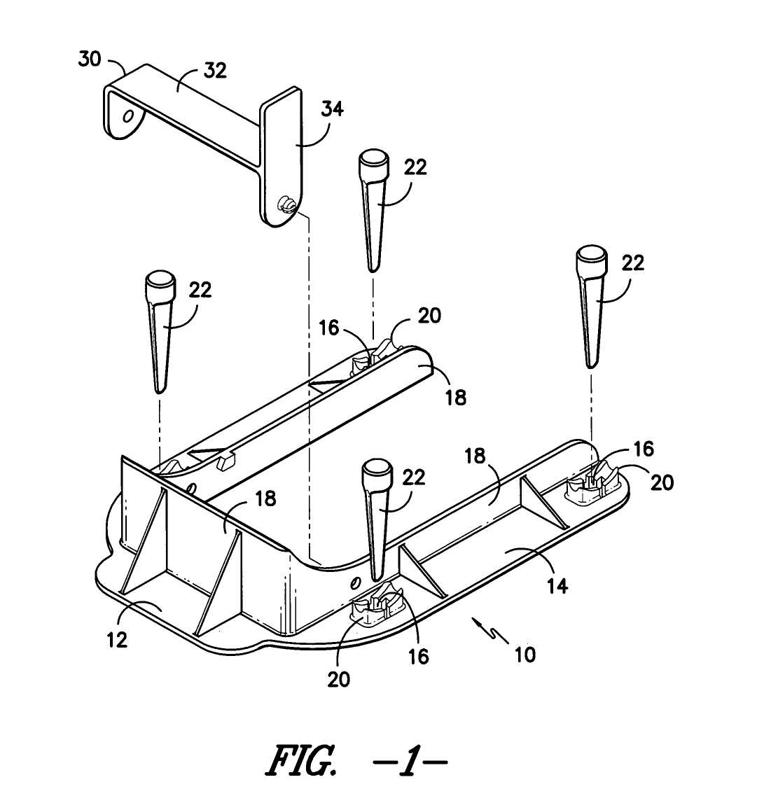

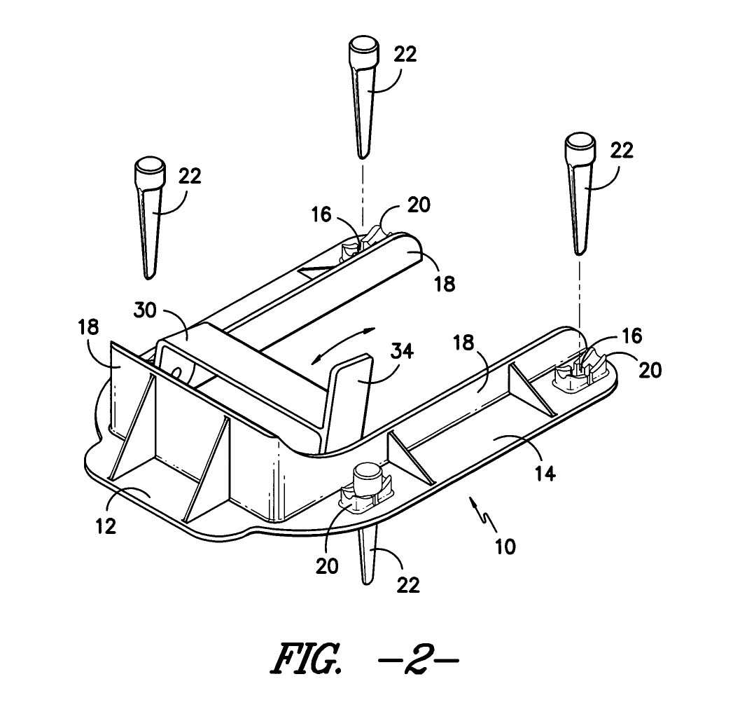

A first embodiment of a ladder brace assembly 10 is shown in FIG. 1. The ladder brace assembly 10, in a preferred embodiment, includes a U-shaped frame member 12 having a base plate 14 with a series of holes 16, and a raised collar section 18 on an inner periphery of the base plate 14. The holes 16 may include reinforced retention collars 20 to provide additional strength and may receive nails, screws, pins 22, stakes 36 or other means of attachment for securing the brace assembly 10 to a support surface for a ladder 24. For instance, if the ladder 24 is used on dirt or soil, a user simply places the brace 10 in a desired location and then secures the brace 10 to the ground by hammering the stakes 36 through the holes 16 and into the ground. Once the pair of ladder braces 10 are in place, the shoes 26 of the ladder 24 may be placed within the U-shaped frames 12, so that the ladder shoes 26 but up against the raised collar sections 18, thus preventing the ladder 24 from sliding along the ground while the ladder 24 is in use. In one embodiment, as shown in FIG. 6, the retention collars are each shaped with a seat that forms an arc, which corresponds to the head of a stake 36 having a vertical ring for ease of removal. The ring portion of the stake 36 may fit down into the retention collar, which provides a secure fit and ensures that the rings of the stakes 36 are all oriented in the same direction.

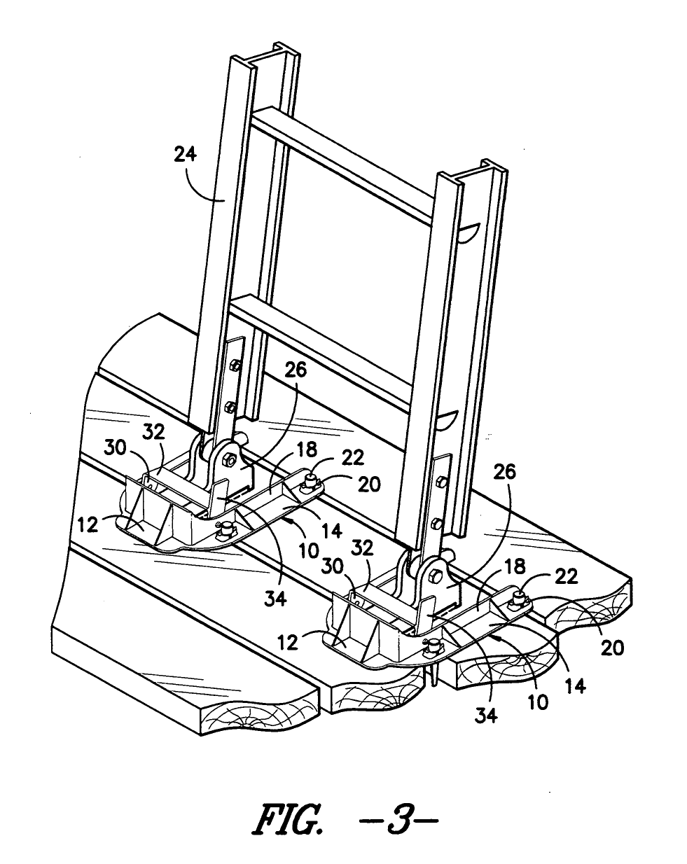

The holes 16 in the base plate 14 are positioned so that, in the event a user wishes to secure the ladder 24 on a deck type surface, the holes 16 are aligned with spaces between the deck boards. Thus, the holes 16 are positioned about 4.5 inches from one another, and the brace 10 may be oriented in a longitudinal direction with respect to the deck boards, or it may be oriented in a lateral direction, as shown in FIG. 3. If necessary, nails may be used to secure the brace 10 directly to the wood.

Alternatively, for hard surfaces such as concrete, double-sided adhesive strips (not shown) may be employed, wherein the adhesive strips are placed on the underside of the base plate 14 in order to temporarily secure the brace 10 to the hard surface. Optionally, a pivoting pin or rod (not shown) may be attached to an outer portion of the raised collar section 18 in order to gauge safe angles of the ladder 24. Angle markings may be printed adjacent the pivoting pin or rod, and when a ladder 24 is set into the braces 10, the pivoting pin or rod may be raised to a position parallel with the ladder 24, and then the ladder angle may be checked to ensure that it is positioned at a safe angle for climbing.

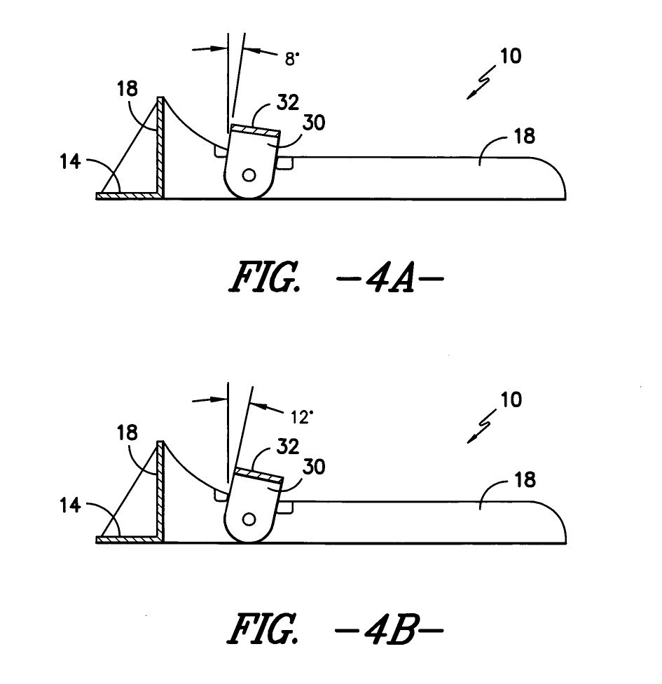

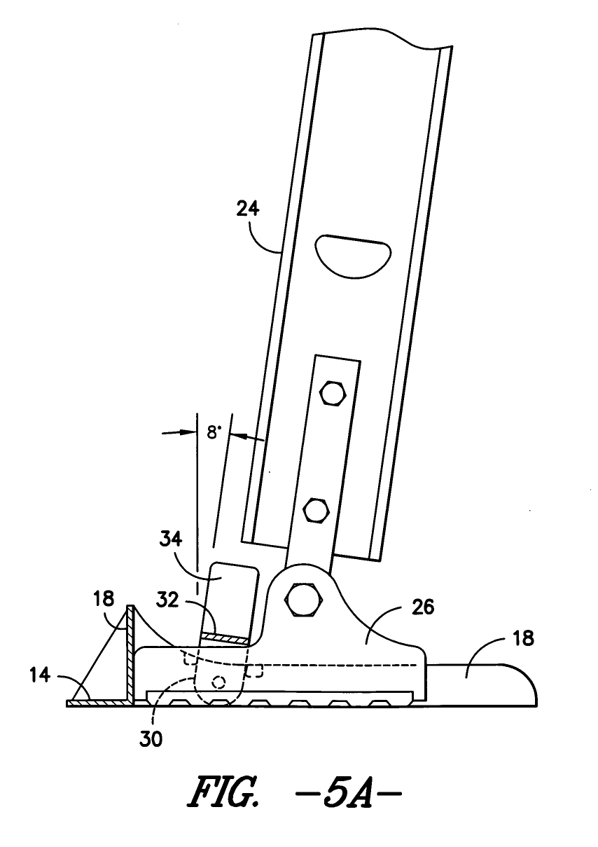

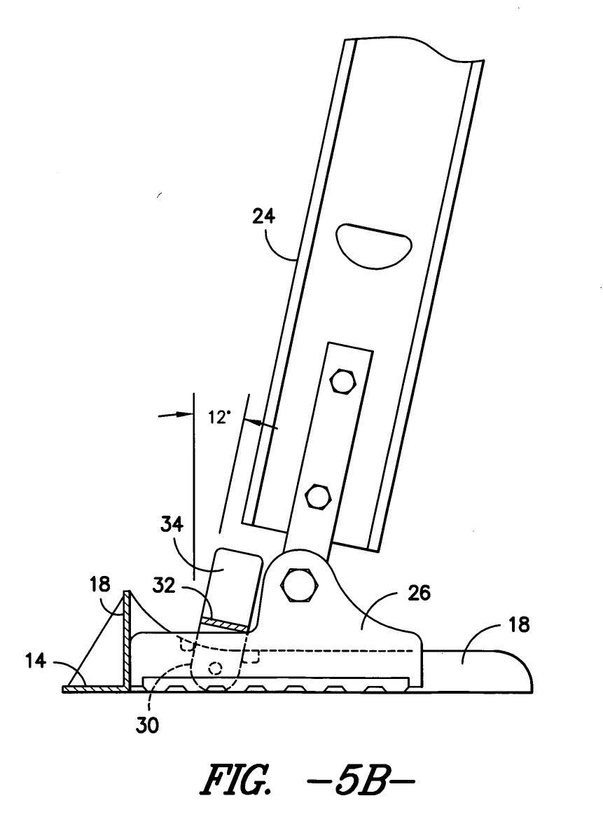

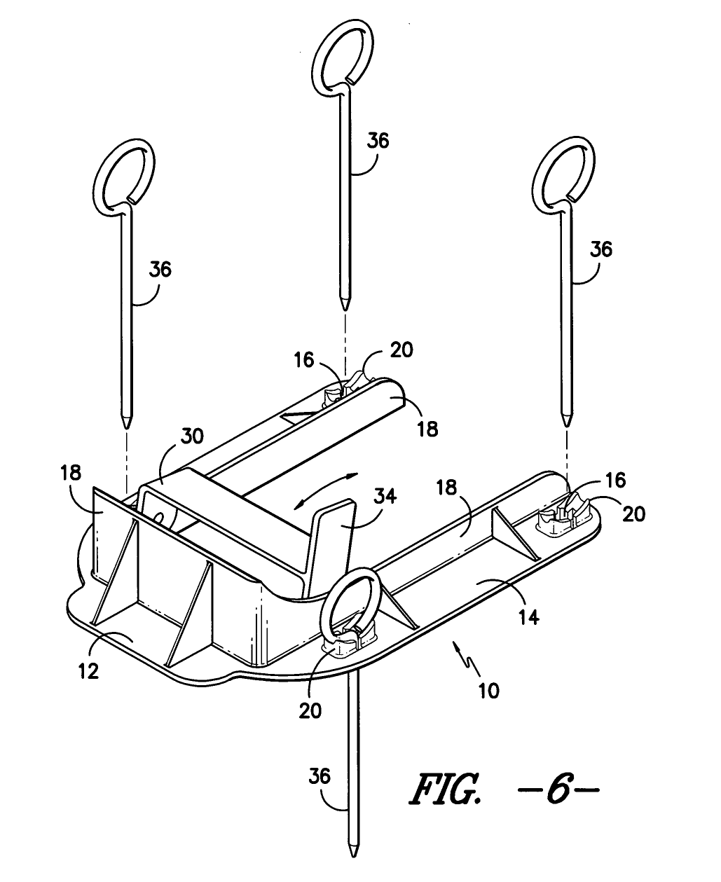

Another option includes a pivoting angular guide 30 which is used to ensure that the ladder angle is within a proper range for use. In a preferred embodiment, the angular guide member provides that the ladder will be in the range of 8 to 12 degrees from vertical, as shown in FIGS. 4A, 4B, 5A and 5B. The pivoting angular guide 30 is attached to the side portions of the raised collar section 18, and may include markings to measure the angle of the ladder 24. The pivoting angular guide 30 includes a cross brace 32 and a handle member 34 for a user to grip while setting the angular guide 30 in a desired position. If the ladder 24 includes a pivoting shoe 26, as shown in FIGS. 3, 5A and 5B, the cross brace 32 may be disposed above the shoe 26 of the ladder as a type of brace or stirrup to prevent the ladder shoe 26 from becoming dislodged from the ladder brace assembly 10.

When the braces 10 are secured to the ladder support surface (deck, ground, driveway, etc.), each shoe 26 of the ladder 24 is disposed within a U-shaped frame 12, and each shoe 26 of the ladder 24 buts up against the raised collar section 18 of the corresponding brace 10, preventing further movement of the ladder 24 with respect to the support surface while the ladder 24 is in use.

This arrangement allows a single user to secure the position of the ladder 24 prior to and during use, thus reducing the need for a second person to hold the ladder 24 while the first person is standing on the ladder 24. When the ladder 24 is no longer needed, the braces may simply be removed from the support surface by removing the nails, pins 22, stakes 36, screws, or other attachment means.

In order to use the ladder braces 10, a user selects a location for the ladder 24. If the ladder 24 is to be used on dirt or soil, preferably a level surface is selected. The ladder 24 may then be placed where desired, and the braces 10 are set on the support surface so that the ladder shoes 26 are positioned within the U-shaped frames 12 of each brace. Then the user secures the braces 10 to the support surface (using stakes 36 through the holes 16 in the base plate 14 for dirt surfaces, pins 22 or nails for decks and wood surfaces, or adhesive tape or other types of temporary adhesive means for concrete or other hard surfaces). It is also contemplated that nails or pins 22 having a rubber O-ring or washer disposed about the shaft beneath the head may be used in order to protect the ladder brace assembly from damage when a user inserts and drives the pins or nails into the holes. Additionally, the O-rings or rubber washers may prevent the nail or pin from being inserted too deeply, which facilitates removal of the nails or pins 22 when the ladder brace assembly 10 is to be removed from the support surface. When the ladder 24 is no longer in use, the attachment means may be removed, and the braces 10 may then be removed from the surfaces.

The ladder braces 10 may be manufactured from metal, sturdy plastic, or any other suitable material. It is contemplated that the ladder brace assembly 10 may be made using an injection molding process. Optionally, the raised collar section 18 may include a protruding horizontal lip (not shown) along the top of the upper edge of the collar section 18 (positioned on the raised collar section at the rear of the ladder shoe 26, on an opposed side from the vertical surface supporting the top of the ladder 24), as a safety mechanism to ensure that the ladder angle is appropriate for climbing. Similarly to the pivoting angular guide 30, the protruding horizontal lip prevents the ladder 24 from leaning at an angle too close to vertical, and allows the ladder shoe 26 to slide thereunder for additional support and stability.

It is further contemplated that the ladder braces 10 set forth herein may be used for ladders 24 of various types, and further may be used with scaffolding, and the like, in the same or similar manner.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A ladder brace comprising:
a generally U-shaped frame member including a base plate and a raised collar section positioned on an inner periphery of said base plate;
attachment means for removably securing said ladder brace to a support surface;
wherein a foot or shoe of a ladder may be positioned within said U-shaped frame to prevent said ladder from skidding or sliding with respect to said support surface.

2. The ladder brace set forth in claim 1, wherein said attachment means include holes in said base plate.

3. The ladder brace set forth in claim 2, wherein said holes are spaced apart by about 4.5 inches from one another, in order to correspond with standard spacing between deck boards.

4. The ladder brace set forth in claim 2, wherein said attachment means further includes nails, stakes, pins or screws.

5. The ladder brace set forth in claim 1, wherein said attachment means includes an adhesive.

6. The ladder brace set forth in claim 1, further including a pivoting rod disposed on an outer portion of the raised collar section for conducting angular measurements of said ladder.

7. The ladder brace set forth in claim 1, wherein said raised collar section includes a protruding horizontal lip on an upper portion thereof.

8. The ladder brace set forth in claim 1, further including a pivoting angular guide positioned on said raised collar section.

9. A method for securing a ladder or scaffolding comprising the steps of:
providing a pair of ladder braces, each brace having a generally U-shaped frame including a base plate and a raised collar section about an inner periphery of said base plate;
securing said pair of ladder braces to a support surface; and
placing a ladder in an operating position so that the feet of said ladder are disposed within said U-shaped frame of said ladder braces.

10. The method set forth in claim 9, wherein said base plate includes a plurality of holes, and wherein the step of securing said pair of ladder braces to a support surface includes the steps comprising:
providing a plurality of nails, screws, pins or stakes; and
placing said nails, screws, pins or stakes through said holes in each said base plate in order to anchor said ladder braces to said support surface.

11. The method set forth in claim 9, wherein said raised collar section includes a pivoting rod attached thereto for conducting angular measurements of said ladder; and further comprising the step of:
raising said pivoting rod to a position parallel with said ladder and determining whether said angular measurement of said ladder is within an acceptable range.

12. The method set forth in claim 9, wherein said step of securing said pair of ladder braces to a support surface includes the step of providing an adhesive strip on an underside of said base plate.

13. The method set forth in claim 9, wherein said raised collar section includes a pivoting angular guide attached thereto for conducting angular measurements of said ladder; and further comprising the step of:
positioning said pivoting angular guide to a position parallel with said ladder and determining whether said angular measurement of said ladder is within an acceptable range.
